(19) United States
(12) Patent Application Publication
(10) Pub. No.: US 2013/0066786 A1
(43) Pub. Date: Mar. 14, 2013

(54) METHOD AND SYSTEM FOR PROVIDING AN INTERNET BASED TRANSACTION

(71) Applicant: John Anthony Joyce, South Yarra (AU)

(72) Inventor: John Anthony Joyce, South Yarra (AU)

(21) Appl. No.: 13/511,610

(22) PCT Filed: Nov. 23, 2010
(86) PCT No.: PCT/AU2010/001570

§ 371 Date: Dec. 3, 2012

Related U.S. Application Data
(60) Provisional application No. 61/264,152, filed on Nov. 24, 2009.

(51) Int. Cl. G06F 21/24; G06Q 20/40

(52) U.S. Cl. 705/71; 705/64; 705/75

(57) ABSTRACT

A method of providing an Internet based transaction for goods or services offered via a website, the method comprising requesting from the website a secure financial transaction from a merchant associated with the website for said goods or services using an Internet access device, activating an encryption device in data communication with the Internet access device, receiving from the encryption device encrypted user financial card details for the secure financial transaction, the Internet access device transmitting the received encrypted user financial card details over the Internet to a transaction server, decrypting the received encrypted user financial card details at the transaction server, and forwarding the decrypted card details to a financial institution in data communication with the transaction server and thereafter using the decrypted card details to complete the secure financial transaction for the Internet based transaction for said goods or services.

### FIELD

This invention relates to a method and system for providing an Internet based transaction for goods or services particularly, but not exclusively, to a secure financial transaction using encrypted user financial card details over the Internet; and to an encryption device for providing the secure financial transaction. This application is based on and claims the benefit of the filing date of U.S. application No. 61/264,152 filed 24 Nov. 2009, the content of which as filed is incorporated herein by reference in its entirety.

### BACKGROUND

Hitherto, a merchant wishing to provide goods or services over the Internet would typically offer such goods via a website. Also, the website would typically have a facility to complete a financial transaction for the goods or services. In this case, the website may include a facility to receive financial information, generally in the form of a credit card number or a bank account number entered by a user browsing the website using a PC, and then transfer this information to a financial institution to complete the financial transaction, i.e. transfer funds from the user to the merchant for the goods. Alternatively, the website may include a link to the financial institution and thus use the financial institution's website facilities to obtain payment to complete the financial transaction based on the user entered financial information. In both cases, the user is required to enter an unencrypted credit card number or bank account number via the website which is accessible via the Internet or the PC, or both.

Another existing method of providing an Internet based transaction uses encryption techniques to encrypt user entered financial information, such as credit card or bank account details, on the PC before transmission to the financial institution to complete the financial transaction. However, the unencrypted financial information is accessible by the PC and thus any programs resident on the PC, e.g. Trojan programs, which may be accessible via the Internet.

### SUMMARY OF THE INVENTION

According to a first broad aspect of the present invention there is provided a method of providing an Internet based transaction for goods or services offered via a website, the method comprising:

requesting from the website a secure financial transaction from a merchant associated with the website for said goods or services using an Internet access device;

activating an encryption device in data communication with the Internet access device;

receiving from the encryption device encrypted user financial card details for the secure financial transaction;

the Internet access device transmitting the received encrypted user financial card details over the Internet to a transaction server;

decrypting the received encrypted user financial card details at the transaction server;

forwarding the decrypted card details to a financial institution in data communication with the transaction server and thereafter using the decrypted card details to complete the secure financial transaction for the Internet based transaction for said goods or services.

In one embodiment, the encryption device encrypts the user financial card details for the secure financial; transaction to prevent unencrypted user financial card details being accessible via the Internet or the Internet access device.

In an embodiment, at least the merchant is informed of the completion of the secure financial transaction via the transaction server so that the merchant can then complete the Internet based transaction by providing the goods or services.

In an embodiment, the encryption device comprises a stand alone encryption device

The Internet access device may comprise a PC or other Internet enabled device, such as a PDA. In another embodiment, the website may be resident, or hosted, on an Intranet website accessible by a Local Area Network (LAN) and, in this case, the Internet access device, e.g. a PC, is adapted to browse the website and request a secure financial transaction over the Intranet or LAN.

In an example, the user financial card details comprise a card number and a security code associated therewith, e.g. a credit card, debit card, or cash card, with an associated security code (e.g. a three digit CCV code for a visa card). In another example, the user financial card details comprise a PIN associated with the user financial card. In any case, these details are inputted into the encryption device, for a secure financial transaction, to be encrypted at the device to prevent the unencrypted details being accessible via the Internet or the Internet access device.

It is understood by those persons skilled in the art that other identification data, such as retina or fingerprint identifying data, may be used as an alternative to the PIN or security code. In this case, the encryption device may be adapted to include retina or fingerprint scanners to input such data. Furthermore, persons skilled in the art will appreciate that the financial card may be a smart card with an IC chip, a magnetic stripe card, a proximity card with an RFID tag, etc. In each of these cases respectively the encryption device may be adapted to receive the card number, or a respective account number, using a corresponding reading mechanism, such as a magnetic stripe reader, so that the received card number can be subsequently encrypted. Alternatively, the card number may be inputted into the encryption device using an input means, such as a keypad.

In an embodiment, the activating of the encryption device is performed by the Internet access device which first activates the encryption device and then waits to receive the encrypted user financial card details. In this case, the card number may be read from the user financial card, or be inputted, and the read card number is subsequently encrypted before being forwarded to the Internet access device. Generally, the card number is encrypted along with an inputted associated PIN or security code to form the encrypted card details. Alternatively, the activating of the encryption device may be performed by swiping or inserting the user financial card thereto. In any case, the encryption device may be maintained in a stand-by mode until required for a secure financial transaction.

In an embodiment, the encrypted financial card details may be transmitted from the Internet access device to the transaction server by an application resident on the Internet access device and dedicated to the secure financial transaction. In addition, the application resident on the Internet access device may activate the encryption device upon request of a secure financial transaction.

It is understood by those persons skilled in the art that the encryption of the user financial card details may be performed by various algorithms at the encryption device, such as AES (128, 192, and 256 bit), DES, Triple DES (2-key and 3-key), ECDSA (160, 192, and 256 bit keys), DSA, RSA (up to 2048 bits), SHA-1, SHA-224, and SHA-256. Furthermore, (e.g. when using the Triple DES algorithm) the encryption of the user financial card details may include encryption with a master key associated with the encryption device.

In an additional embodiment, the encryption of the user financial card details further includes encryption with a one-time key associated with the requested secure transaction in association with the master key. The master key and one-time key may be obtained by the transaction server, upon request, to decrypt the received encrypted card details. Alternatively, the master key and the one-time key may be registered and stored at the transaction server or may be derived at the transaction server using a stored algorithm.

In an embodiment, the method further comprises using the master key and the one-time key for decrypting the received encrypted user financial card details by the transaction server.

It will be appreciated by those persons skilled in the art that the financial institution may incorporate an acquiring bank associated with the merchant and an issuing bank associated with the user financial card details. In this case, the decrypted card details, decrypted by the transaction server, may be forwarded from the acquiring bank to the issuing bank to obtain payment from the issuing bank to complete the secure financial transaction.

In an example, the Internet based transaction comprises providing access to a user bank account associated with the user financial card details which is associated with the issuing bank. In this example, the encryption device may be adapted to receive the card number to be subsequently encrypted, as described above, and the issuing bank uses the decrypted card details, decrypted as described above, to allow user access to the user's bank account to perform secure transactions. The encryption device may also further encrypt the card number with an inputted associated PIN, as described above, to provide more secure access to the user's bank account.

In an embodiment, the financial card is a cash card and the Internet based transaction comprises reloading the cash card.

According to another broad aspect of the present invention there is provided a system for providing an Internet based transaction for goods or services offered via a website, the system comprising:

an Internet access device adapted to browse a website and request from the website a secure financial transaction from a merchant associated with the website for said goods or services;

an encryption device in data communication with the Internet access device and adapted to be activated when the secure financial transaction is requested, to encrypt user financial card details for the secure financial transaction, encryption device and to forward the encrypted user financial card details to the Internet access device; and

a transaction server adapted to receive and decrypt the encrypted user financial card details received from the Internet access device over the Internet, wherein the transaction server forwards the decrypted card details to a financial institution in data communication with the transaction server to thereafter use the decrypted card details to complete the secure financial transaction for the Internet based transaction for the goods or services.

In an embodiment, the system includes an authentication server adapted to receive merchant details upon request for the secure financial transaction from the website over the Internet to authenticate the request. For example, the authentication server may receive details from the website regarding whether the website is an approved website, and thus whether the merchant is approved to participate in the secure financial transaction. If so, the authentication server may activate an application resident on the Internet access device dedicated to the secure financial transaction upon authentication of the request of the secure financial transaction. In the example, the activated application may then activate the encryption device and wait for the encrypted cards details from the encryption device. Furthermore, in an embodiment, the authentication server may receive the encrypted card details from the Internet access device via a secure protocol, such as SSL or TLS, for secure communication over the Internet.

In an embodiment, the authentication server generates a one-time key associated with the secure financial transaction upon authentication of the request for the secure financial transaction.

In another example, the authentication server generates the one-time key upon authenticating the request for the secure financial transaction. In any case, the generated one-time key may then be forwarded to the encryption device so that it may be used in the encryption of the financial card details along with the master key.

In another embodiment, the authentication server receives the encrypted user financial card details from the Internet access device over the Internet and authenticates the encryption device using the received encrypted card details. For example, the authentication server may transmit the received encrypted card details to the transaction server if the encryption device is authenticated with the encrypted card details being sent either over the Internet or a dedicated network such as a LAN to the transaction server. In an example, the authentication server retrieves the master key from the received encrypted card details and compares this against at least one known master key for authentication of the encryption device.

In addition, the authentication server may be informed of completion of the secure financial transaction by the transaction server (e.g. the acquiring bank obtained payment from the issuing bank), and subsequently informs at least the merchant of that completion so the merchant can then complete the Internet based transaction by providing the goods or services. Also, the authentication server may subsequently inform the Internet access device of the completion of the secure financial transaction to alert the application to de-activate the encryption device and alert a user of the Internet access device of the completion of the secure financial transaction.

In an embodiment, the system comprises a payment gateway comprising the transaction server. It will be appreciated by those persons skilled in the art that the payment gateway is an electronic transaction service provider that enables secure transfer of card details from the Internet access device to the financial institution using the transaction server. The payment gateway may thus decrypt the received encrypted card details for secure transfer to the financial institution using financial institution protocols and thus acquiring and issuing bank compatible protocols. In an alternative embodiment, the payment gateway also includes the authentication server with the above described functions.

According to another broad aspect of the present invention there is provided an encryption device for providing a secure financial transaction for an Internet based transaction for goods or services offered via a website associated with a merchant, the encryption device adapted to:

encrypt user financial card details for the secure financial transaction upon request by an Internet access device in data communication with the encryption device; and

forward the encrypted user financial card details to the Internet access device to be transmitted over the Internet to a transaction server to be decrypted for subsequent forwarding to a financial institution in data communication with the transaction server to thereafter be used to complete the secure financial transaction for the Internet based transaction for the goods or services.

In an embodiment, the encryption device connects to an Internet access device, such as a PC running any supported operating system such as Windows, MAC OS, Unix, and Open Source Operating Systems, generally via a USB 1.1 or USB 2.0 connection. Also, other connections are also envisaged such as a PCI connection. In any event, the encryption device may also be compliant with other communication and encryption protocols for encrypting and forwarding encrypted card details to the Internet access device, such as ISO7816-1,2,3,4, USB, USBCV Test, PS/SC, USB CCID Driver, DES, 3DES, RSA, ANSI 9.24, EMV Level 1, Microsoft WHQL, etc. In addition, the encryption device may contain a 32 bit RISC chip set to enables low power, single-cycle processing, tamper-detection technology, and advanced cryptographic hardware to provide data security and secret key protection. Such a chip set may also be compliant with ITSEC E3 High, FIPS 140-2 Level 3, Common Criteria certifications, etc, to achieve the security features of the encryption device.

In an embodiment, the encryption device is injected with a master key, e.g. a secret key that cannot be retrieved from the device. The master key may be pre-registered with the transaction server and authentication server, or obtained using a known algorithm, for encryption/decryption of the card details and authentication of the device.

In an embodiment, the encryption device is a stand alone encryption device however it will be appreciated by those skilled in the art that the stand alone encryption device may receive power from the PC, for example via USB, or may have an external power supply, but may also receive instructions from the PC, such as ‘turn ON’ or the one-time key as described above. Nonetheless, the PC cannot retrieve any information from the encryption device 12 other the encrypted card details, so only encrypted information is accessible via the Internet and the PC.

According to another broad aspect of the present invention there is provided computer program code usable to configure a server to process a secure financial transaction for an Internet based transaction for goods or services offered via a website associated with a merchant, the server being configured to:

receive a request over the Internet for the secure transaction by an Internet access device;

receive from the Internet access device encrypted user financial card details encrypted using an encryption device for the secure financial transaction decrypt the encrypted user financial card details; and

forward the decrypted card details to a financial institution to thereafter be used to complete the secure financial transaction for the Internet based transaction for the goods or services.

According to another broad aspect of the present invention there is provided computer program code which when executed implements the above method.

According to another broad aspect of the present invention there is provided a tangible computer readable medium comprising the above program code.

According to another broad aspect of the present invention there is provided a data file comprising the above program code.

### BRIEF DESCRIPTION OF DRAWINGS

In order that the invention can be more clearly ascertained, examples of embodiments will now be described with reference to the accompanying drawings, wherein:

FIG. 1 is a schematic view of a system for providing an Internet based transaction for goods or services according to an embodiment of the invention;

FIG. 2 is a further schematic view of the system of FIG. 1;

FIG. 3 is a further schematic view of the system of FIG. 2 showing a payment gateway;

FIG. 4 is a plan view of an encryption device for providing a secure financial transaction for an Internet based transaction for goods or services according to an embodiment of the invention;

FIG. 5 is a flow chart of a method of providing a secure financial transaction for an Internet based transaction for goods or services according to an embodiment of the invention; and

FIG. 6 is a further flow chart of the method of FIG. 5 showing a method of performing a secure financial transaction.

### DETAILED DESCRIPTION

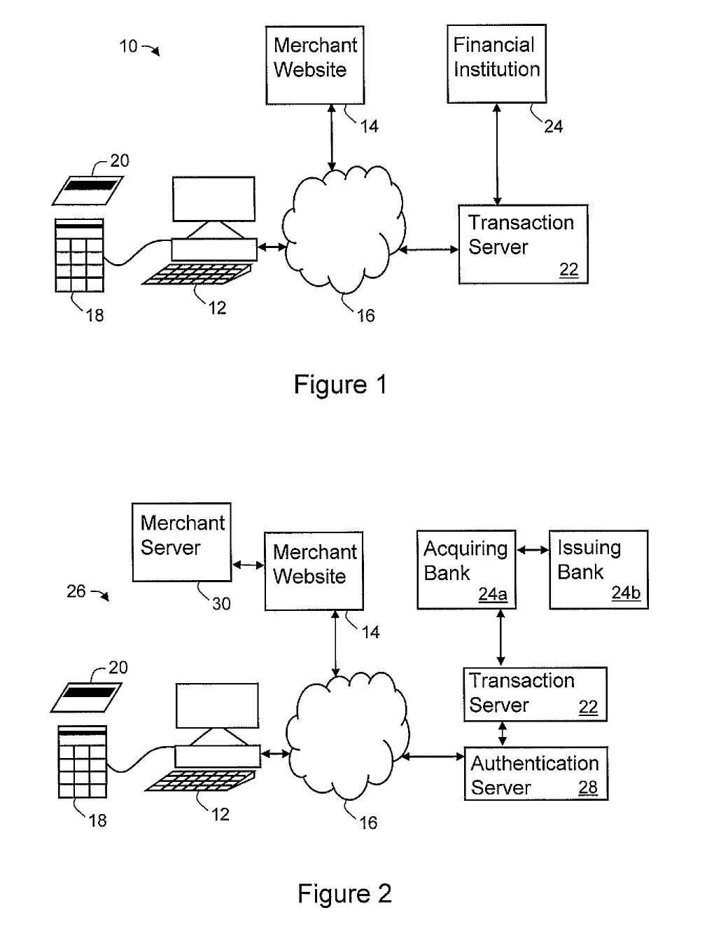

According to an embodiment of the present invention, there is provided a system 10 for providing an Internet based transaction for goods or services offered by a merchant, as shown in FIG. 1. The system 10 includes an Internet access device 12 adapted to browse a website 14 offering goods over the Internet 16 to request a secure financial transaction for the goods from the merchant associated with the website 14. The system 10 further includes an encryption device 18 adapted to encrypt user financial card details for the secure financial transaction to prevent unencrypted card details being accessible via the Internet 16 or the Internet access device 12. As described, the Internet access device 12 may be a PC 12 and the encryption device 18 is adapted to encrypt and subsequently forward the encrypted card details to the PC.

As described, the encryption device 12 may be adapted to receive user financial card details in the form of a financial card 20 details, e.g. a credit or debit card details. In this case, the device 12 may include a magnetic stripe reader to read the card number, e.g. a credit card number, from the magnetic stripe of the card 20. Alternatively, the card 20 may contain an IC chip and the encryption device 12 may include a chip reader to read the corresponding card number from the chip for subsequent encryption. In a further embodiment, the card number may be inputted into the encryption device 18 using a keypad which may also be used to input a security code or PIN associated with the card number for encryption with the card number for further security.

In an embodiment, a user browsing a website using the PC 12 requests from the website a secure financial transaction for a transaction for goods, which prompts the PC 12 to wait for encrypted card details from the encryption device 18. The user may then activate the encryption device 18 to receive the card 20 and thus read or otherwise retrieve the corresponding card number for encryption by inputting a card into the card reader or pressing a key of a keypad. In any case, the encrypted card details may then be forwarded to the PC 12, which is not adapted to decrypt the encrypted details but transmits these details over the Internet 16 to a transaction server 22 for processing.

In the embodiment, the transaction server 22 decrypts the received encrypted card details and puts them in a format for forwarding to a financial institution 24, e.g. a bank. As described, the encryption may be a triple DES algorithm where the user financial card details may be encrypted at the encryption device 12 with a master key associated with the encryption device 12 and a one-time key associated with the requested secure transaction. That is, the encryption device 12 may be injected with a unique master key that may be known to, or otherwise obtained by, the transaction server 22. For example, the master key is generated with an algorithm similar to a credit card number generation algorithm and this algorithm is known to the transaction server 22 so that the master key can be obtained for decryption. Likewise, the one-time key may be generated by a similar algorithm.

In the example, the user browses a website 14 using the PC 12 and requests from the website a secure financial transaction for a transaction for goods. This request is then transmitted over the Internet 16 to the transaction server 22 which processes the secure financial transaction component of the Internet based transaction. The transaction server 22 then generates a one-time key associated with the requested secure financial transaction, which is to be transmitted to the PC 12 and thus to the encryption device for use in the encryption process. As described, the encryption device 18 encrypts the user financial card 20 details with the master key and the one-time key, and forwards the encrypted card details to the PC 12 which then transmits these details to the transaction server 22 for decryption to be forwarded to a financial institution 24, which may then use the card details to withdraw funds from the user's bank account and forward funds to the merchant as payment for the goods. It will be appreciated by those persons skilled in the art that the communication between the transaction server 22 and the financial institution 24 is over a secure network.

In the example, the financial institution may then complete the secure financial transaction by paying the merchant for the goods and the merchant is informed of this payment so that the merchant can complete the Internet based transaction and provide the goods. In an embodiment, the transaction server 22 is informed of the completion so that it may inform the merchant and the user.

In another embodiment, there is provided a system 26 for providing an Internet based transaction for goods as shown in FIG. 2. The system shown in FIG. 2 shows the financial institution 24 (shown in FIG. 1) incorporating an acquiring bank 24a associated with the merchant and an issuing bank 24b associated with the user financial card. As described, during a requested secure financial transaction, the decrypted card details, decrypted by the transaction server 22, are transmitted to the acquiring bank 24a in a format suitable for the bank which then forwards the card details to the issuing bank 24b and retrieves the required funds to complete the secure financial transaction.

In an embodiment, the system includes an authentication server 28 which may be adapted to receive details of the merchant from the website 14, over the Internet 16, to authenticate the user request for a secure financial transaction. In the embodiment, the merchant website is hosted on a merchant server 30 and details of the merchant, such as company name and address, may be stored on the server 30 and transmitted over the Internet 16 to the authentication server 28 upon request of the secure financial transaction. It will be appreciated by those skilled in the art that the secure financial transaction may be performed using a further server incorporating some or all the features of the transaction server 22 and the authentication server 28. For example, the user browses the website 14 to purchase goods (i.e. make an Internet based transaction), and, when required to pay for the goods, selects an option of requesting a secure financial transaction by selecting a link present on the website 14. The link then navigates the user away from the merchant website to a website hosted on the further server which then prompts the user to swipe or insert the card 20 into the device 18.

In an alternative embodiment, the user may be prompted to swipe their card 20 at the encryption device 18 by an application resident on the PC which is dedicated to the secure financial transaction and is activated by the request.

It is to be appreciated by those skilled in the art that functions of the further server, such as hosting the further website, may be performed by the authentication server 28, and functions of decrypting may be performed by transaction server 22. In an example, the authentication server 28 may activate an application resident on the PC 12 and dedicated to the secure financial transaction rather than using a further website dedicated the transaction, upon authentication of a request for the secure financial transaction. That is, following a user request for a secure financial transaction, the website 14 forwards the request to the authentication server 28 along with merchant details to authenticate the request and thus determine whether the merchant is eligible to participate in the secure financial transaction. If so, the authentication server 28 may activate the application to begin the secure financial transaction method as described.

In addition, the authentication server 28 may be adapted to receive the encrypted card details over the Internet 16 from the PC 12 to authenticate the encryption device 12 using the received encrypted card details before forwarding the encrypted card details to the transaction server 22. In this case, the authentication server 28 may be adapted to retrieve the master key from the received encrypted card details and compare this against a known master key, or a known algorithm for generating a master key, to authenticate the encryption device before forwarding the encrypted card details to the transaction server 22. Also, after the acquiring bank 24a receives funds for the goods, the acquiring bank may inform the transaction server 22 of the completion of the secure financial transaction which subsequently informs the authentication server 28 so that it may inform the merchant of that completion, via the merchant website 14, so the merchant can then complete the transaction by providing the goods. The authentication server 28 may also inform the user, via the PC 12, that the funds have been withdrawn from the account associated with the card 20 and the secure financial transaction has been successfully completed.

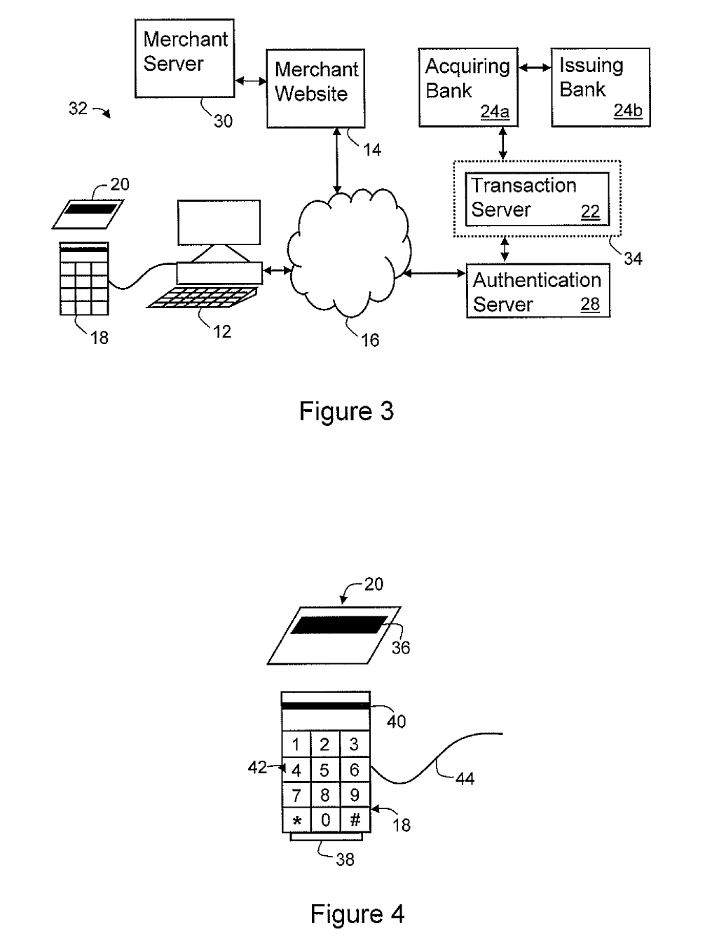

According to another embodiment of the present invention, there is provided a system 32 for providing an Internet based transaction for goods or services offered by a merchant, as shown in FIG. 3. The embodiment includes a payment gateway 34 incorporating the transaction server 22, so that the payment gateway 34 may receive encrypted card details, decrypt them and place them in a format suitable for communication to the acquiring bank 24a to withdraw funds from the issuing bank 24b and to complete the secure financial transaction. Therefore, in the example, the user browsing the website 14 requests a secure financial transaction by selecting an option from the merchant website 14 which then forwards merchant details to the authentication server 28 along with the request and following the encryption process described, forwards the encrypted card details to the payment gateway 34 for processing.

FIG. 4 shows the encryption device 18 and the financial card 20 according to an embodiment of the present invention. The financial card 20, e.g. a credit card, has a magnetic stripe 36 adapted to be read by a magnetic stripe reader 40 of the device 18. The device 18 also has an IC chip reader 38 for reading IC chips on smart cards, including credit, cash, or debit cards. In addition, the device 18 includes a magnetic stripe writer and an IC chip writer to write information to respective cards, such as crediting or withdrawing credits from pre-paid smart cards. In an example, the cash card comprises pre-paid credits and the user may browse a website 14 to request a transaction to recharge or reload credits to the cash card. In this case, a secure financial transaction is requested and performed as above but the authentication server 28 when informed of the completion of the secure financial transaction further instructs the application residing on the PC to prompt the user to insert the cash card into the device 18 so that the device 18 can write the credits to the card using the corresponding writer.

In an embodiment, the encryption device 18 also includes a key pad 42 for a user to enter a security code or a PIN associated with the card 20, or to enter the card or account number associated with the card 20 if the respective reading mechanisms are not working. Also, the device 18 may be connected to the PC 12 with a cable 44, such as a USB cable. However, it is envisaged that other connections may be deployed such as wireless.

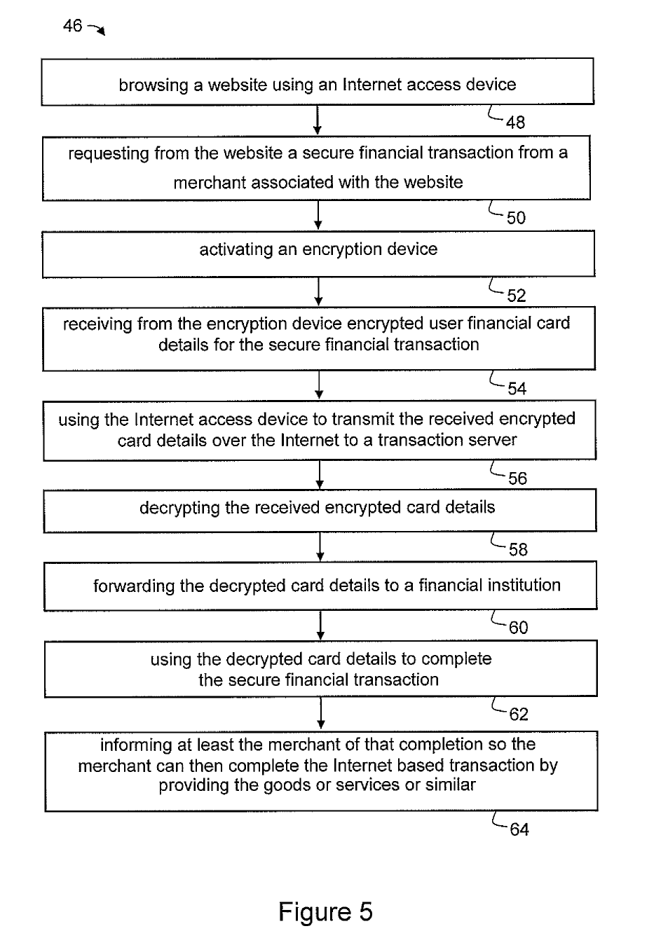

According to another embodiment of the present invention, there is provided a method 46 of providing an Internet based transaction for goods or services implemented by the system 10, which is summarised in FIG. 5. The method 46 includes browsing 48 a website using an Internet access device, requesting 50 from the website a secure financial transaction from a merchant associated with the website for goods offered via the website, activating 52 a encryption device, receiving 54 from the encryption device encrypted user financial card details for the requested secure financial transaction, and using 56 the Internet access device to transmit the encrypted user financial card details over the Internet to a transaction server. In addition, the method 46 includes decrypting 58 the encrypted user financial card details at the transaction server and forwarding 60 the decrypted card details to a financial institution, the financial institution using 62 the decrypted card details to complete the secure financial transaction, and subsequently informing 64 the merchant of that completion so the merchant can complete the Internet based transaction and provide the goods to the user.

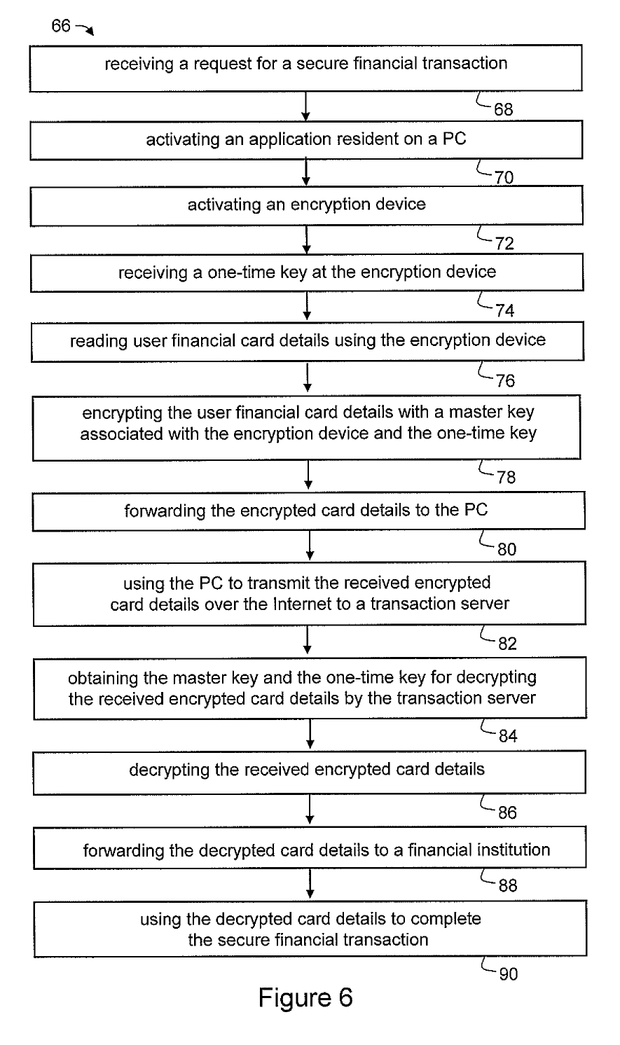

In a further embodiment, a method 66 of performing a secure financial transaction implemented by the system 10 for the purchase of goods is summarised in FIG. 6. The method 66 includes receiving 68 a request for a secure financial transaction from the website as described above, activating 70 an application resident on a PC dedicated to the secure financial transaction, and subsequently activating 72 the encryption device in data communication with the PC. The method 66 further includes receiving 74 a one-time key associated with the secure financial transaction at the encryption device, reading 76 user financial card details by the device and subsequently encrypting 78 the user financial card details with the received one-time key and a master key associated with the device. In addition, the method 66 includes forwarding 80 the encrypted card details to the PC and using 82 the PC, via the application, to transmit the encrypted card details over the Internet to a transaction server. The method 66 then includes obtaining 84 the master key and the one-time key and subsequently decrypting 86 the received encrypted user financial card details at the transaction server, then forwarding 88 the decrypted card details to a financial institution, and the financial institution using 90 the decrypted card details to complete the secure financial transaction.

Further aspects of the method will be apparent from the above description of the system. Persons skilled in the art will also appreciate that the method could be embodied in program code. The program code could be supplied in a number of ways, for example on a tangible computer readable medium, such as a disc or a memory or as a data signal or data file (for example, by transmitting it from a server).

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of providing an Internet based transaction for goods or services offered via a website, the method comprising:
requesting from the website a secure financial transaction from a merchant associated with the website for said goods or services using an Internet access device;
activating an encryption device in data communication with the Internet access device;
receiving from the encryption device encrypted user financial card details for the secure financial transaction;
the Internet access device transmitting the received encrypted user financial card details over the Internet to a transaction server;
decrypting the received encrypted user financial card details at the transaction server;
forwarding the decrypted card details to a financial institution in data communication with the transaction server and thereafter using the decrypted card details to complete the secure financial transaction for the Internet based transaction for said goods or services.

2. The method of claim 1, wherein the user financial card details comprise a card number and a security code associated therewith.

3. The method of claim 2, further comprising reading the card number from the user financial card at the encryption device.

4. The method of claim 3, further comprising inputting the security code using the encryption device.

5. (canceled)

6. The method of claim 1, further comprising encrypting said user financial card details with a master key associated with the encryption device.

7. The method of claim 6, comprising further encrypting said user financial card details with a one-time key associated with the secure financial transaction.

8. The method of claim 7, further comprising generating the one-time key upon request of the secure financial transaction from the Internet access device at the transaction server.

9. The method of claim 8, further comprising forwarding the generated onetime key to the encryption device for encrypting said user financial card details in association with said master key.

10. The method of claim 9, further comprising using the master key and the one-time key for decrypting the received encrypted user financial card details by the transaction server.

11. The method of claim 1, wherein the financial institution comprises an acquiring bank associated with the merchant and an issuing bank associated with the user financial card details.

12. The method of claim 11, further comprising communicating the decrypted card details to the issuing bank from the acquiring bank to obtain payment from the issuing bank to complete the secure financial transaction.

13. The method of claim 11, wherein the Internet based transaction comprises providing access to a user bank account associated with the user financial card details which is associated with the issuing bank.

14. The method of claim 1, wherein the financial card is a cash card and the Internet based transaction comprises reloading the cash card.

15. The method of claim 1, further comprising transmitting the encrypted financial card details from the Internet access device by an application resident on the Internet access device and dedicated to the secure financial transaction.

16. A system for providing an Internet based transaction for goods or services offered via a website, the system comprising:
an encryption device in data communication with an Internet access device adapted to browse a website and request from the website a secure financial transaction from a merchant associated with the website for said goods and services
the encryption device and adapted to be activated when the secure financial transaction is requested, to encrypt user financial card details for the secure financial transaction, and to forward the encrypted user financial card details to the Internet access device; and
a transaction server adapted to receive and decrypt the encrypted user financial card details received from the Internet access device over the Internet, wherein the transaction server forwards the decrypted card details to a financial institution in data communication with the transaction server to thereafter use the decrypted card details to complete the secure financial transaction for the Internet based transaction for the goods or services.

17. The system of claim 16, further comprising an authentication server adapted to receive merchant details upon request for the secure financial transaction from the website over the Internet to authenticate the request for the secure financial transaction.

18. The system of 17, wherein the authentication server activates an application resident one the Internet access device and dedicated to the secure financial transaction upon authentication of the request for the secure financial transaction.

19. The system of claim 17, wherein the authentication server generates a one-time key associated with the secure financial transaction upon authentication of the request for the secure financial transaction and forwards the one-time key to the encryption device over the Internet via the Internet access device.

20. The system of claim 17, wherein the authentication server receives the encrypted user financial card details from the Internet access device over the Internet and authenticates the encryption device using the received encrypted user financial card details before.

21. The system of 20, wherein the authentication server further transmits the received encrypted user financial card details to the transaction server upon authentication of the encryption device.

22.-24. (canceled)

25. An encryption device for providing a secure financial transaction for an Internet based transaction for goods or services offered via a website associated with a merchant, the encryption device adapted to:
encrypt user financial card details for the secure financial transaction upon request by an Internet access device in data communication with the encryption device; and
forward the encrypted user financial card details to the Internet access device to be transmitted over the Internet to a transaction server to be decrypted for subsequent forwarding to a financial institution in data communication with the transaction server to thereafter be used to complete the secure financial transaction for the Internet based transaction for the goods or services.

26. Computer program code usable to configure a server to process a secure financial transaction for an Internet based transaction for goods or services offered via a website associated with a merchant, the server being configured to:
receive a request over the Internet for the secure transaction by an Internet access device;
receive from the Internet access device encrypted user financial card details encrypted using an encryption device for the secure financial transaction
decrypt the encrypted user financial card details; and
forward the decrypted card details to a financial institution to thereafter be used to complete the secure financial transaction for the Internet based transaction for the goods or services.

27.-29. (canceled)
